(19) United States
(12) Patent Application Publication
(10) Pub. No.: US 2026/0205340 A1
(43) Pub. Date: Jul. 16, 2026

(54) WIDEBAND COMBINED RESAMPLING CHANNELIZER

(71) Applicant: NATIONAL RESEARCH COUNCIL OF CANADA, Ottawa (CA)

(72) Inventors: Thushara Kanchana Gunaratne, Penticton (CA); Brent Carlson, Penticton (CA)

(21) Appl. No.: 19/136,096

(22) PCT Filed: Dec. 6, 2023
(86) PCT No.: PCT/IB2023/062319

§ 371 Date: Jun. 5, 2025

Related U.S. Application Data
(60) Provisional application No. 63/386,397, filed on Dec. 7, 2022.

(51) Int. Cl. H04L 27/26

(52) U.S. Cl. CPC H04L 27/2628

(57) ABSTRACT

A wideband resampling channelizer is provided, comprising a plurality of signal processing modules for generating a plurality of output channels that are adjusted for phase and frequency and tagged with an output time stamp in relation to the input data samples, and a control module for controlling the plurality of signal processing modules based on a plurality of configuration parameters such that channelization and resampling operations are combined.

### FIELD OF THE INVENTION

The present disclosure relates generally to radio astronomy digital signal processing and timing. More particularly, examples of the disclosure relate to a resampling channelizer and method for processing wideband signals.

### BACKGROUND OF THE DISCLOSURE

With advancements in Very Large Scale Integrated Circuit (VLSI) technology and sophisticated digital signal processing algorithms, the bandwidths of signals being processed using specialized high-performance digital signal processing (HP-DSP) devices (e.g. FPGAs, ASICs) have been increasing. Usually, these wideband signals are time de-multiplexed and processed in parallel. A channelizer can be used to segment a wideband signal into number of narrow-bands, and a resampler can be used to change the sample rate of a signal. It is known for some applications in wireless communications, remote sensing, radio astronomy and digital media, to apply channelization and subsequent resampling of wideband signals.

In processing wideband signals, it has been observed that channelizers implemented in FPGAs consume a high number of hardened multipliers (DSP-Blocks/DSP-Slices) and few or no dedicated internal memory-blocks (i.e. M20Ks, Block-RAM). On the other hand, resamplers that operate at sample rates at or lower than the clock rate tend to consume a high number of both hardened multipliers and internal-memory-blocks. Usually, the required resources to instantiate wideband channelizers and resamplers to support each of the resulting channels far exceeds the available resources available in a single digital signal processing devices (e.g. FPGA), with the result that the wideband channelizers and must be instantiated in different digital signal processing devices. This can result in increased cost, power utilization and development/test/verification times due to the use of multiple digital signal processing devices.

The following prior art is relevant to this disclosure: U.S. Pat. No. 6,356,569 issued to Ranjan V. Sonalkar and. Howard David Helms, entitled Digital Channelizer with Arbitrary Output Sampling Frequency, and Scott C. Kim and Shuvra S. Bhattacharyya, “A Wideband Front-End Receiver Implementation on GPUs”, IEEE Transactions on Signal Processing (Volume: 64, Issue: 10, May 2016) .

Any discussion of problems provided in this section has been included in this disclosure solely for the purposes of providing a background for the present invention, and should not be taken as an admission that any or all of the discussion was known at the time the invention was made.

### BRIEF DESCRIPTION OF THE DRAWING FIGURES

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements and wherein:

FIG. 1 illustrates a system for imaging correlation of an input sequence of data frames of a signal, in accordance with the prior art.

FIG. 2A shows operation of a channelizer in the system of FIG. 1, for segmenting the bandwidth of the signal.

FIG. 2B shows operation of a resampler in the system of FIG. 1, for signal resampling the sample points of the signal.

FIG. 3 is a block diagram of a wideband combined resampling channelizer, according to an embodiment.

FIG. 4 is a flowchart showing operation of the wideband resampling channelizer wideband of FIG. 3.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present disclosure.

### DETAILED DESCRIPTION OF EXEMPLARY EMBODIMENTS

As discussed below, a wideband resampling channelizer are provided that combines the signal processing operations of a wideband channelizer and an array of resamplers so as to minimize required digital signal processing resources. In one aspect, a processing architecture of the wideband time de-multiplexed signals is set forth that combines the channelization and the resampling operations and a method for controlling operation of the processing architecture.

In an aspect, a wideband resampling channelizer is provided, comprising a plurality of signal processing modules for generating a plurality of output channels that are adjusted for phase and frequency and tagged with an output time stamp in relation to the input data samples, and a control module for controlling the plurality of signal processing modules based on a plurality of configuration parameters such that channelization and resampling operations are combined.

In another aspect, a wideband resampling channelizer is provided, comprising a control module for receiving delay and phase correction functions and an input time stamp, and in response outputting a plurality of control signals and and output time stamp based on a plurality of configuration parameters, a multiplexer for receiving input data samples and outputting time de-multiplexed input samples based on a multiplexer control signal output from the control module, a data buffer for receiving the time de-multiplexed input samples and outputting a contiguous flow of the data samples based on a buffer-control signal output from the control module, a coefficient-buffer for storing a plurality of fractional filters and outputting selected fractional filters for the contiguous flow of the data samples, based on a fractional delay filter index output from the control module, a multiply and accumulate module for multiplying the samples output from the data buffer by respective coefficients of the fractional filters output from the coefficient buffer for a required delay correction, and accumulating the multiplication product into a frame of samples, a multiply and accumulate module for multiplying the samples output from the data buffer by respective coefficients of the fractional filters output from the coefficient buffer for a required delay correction, and accumulating the multiplication product into a frame of samples, an inverse fast Fourier transform module for performing an inverse fast Fourier transform on the frame of samples, sine-cosine look up table for storing a plurality of multiplication factors, and an array of complex multipliers for multiplying the frame of samples output from inverse fast Fourier transform module by corresponding multiplication factors from the sine-cosine look up table based on phase compensation indices output from the control module and in response outputting a plurality of output channels that are adjusted for phase and frequency and tagged with the output time stamp for relation to the input data samples.

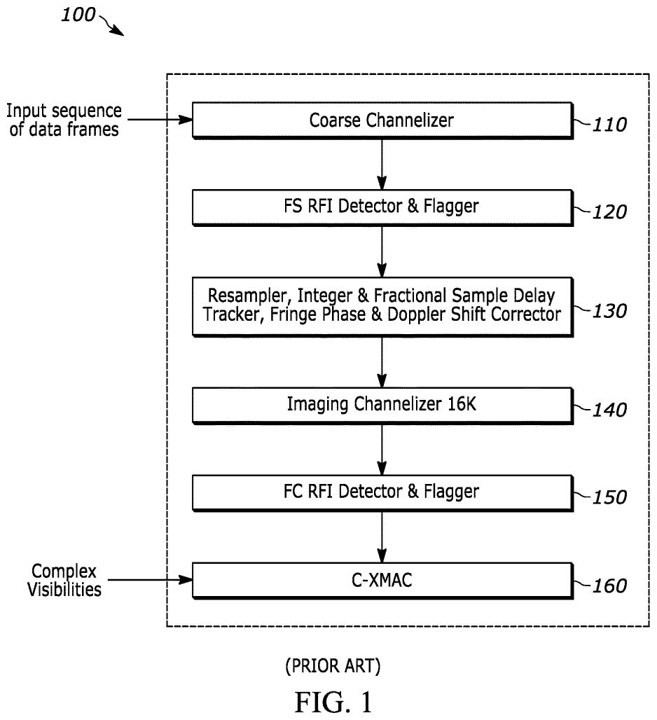

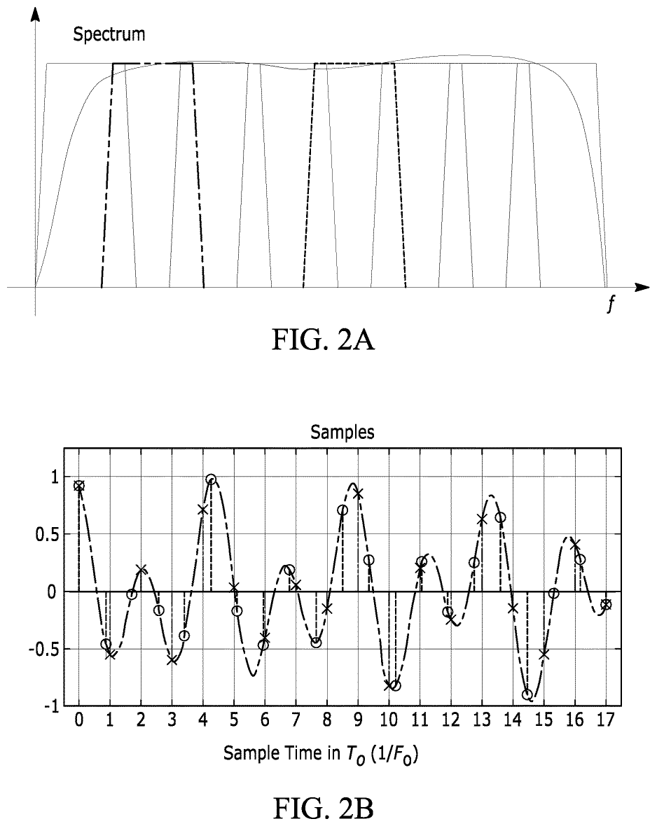

Turning to FIG. 1, a system 100 is shown for imaging correlation of an input sequence of data frames, for example in a radio telescope, in accordance with the prior art. A coarse channelizer 110 segments the bandwidth of the signal, as shown in FIG. 2A. A Frequency Slice (FS) radio frequency interference (RFI) detector and flagger 120 to continuously monitor quality before signal processing by a resampler, integer & fractional sample delay tracker, fringe phase and doppler shift corrector 130, where signal resampling changes the sample points of the signal, as shown in FIG. 2B, for changing the sample rate, capturing signal; profile, etc. After resampling, the signal is further processed by an imaging channelizer 140, second Fine Channel (FC) RFI detector and flagger 150 and complex cross multiplier-accumulator (C-XMAC) 160. As noted above, in such prior art systems the channelizer 110 and resampler 130 are implemented as different digital signal processing devices.

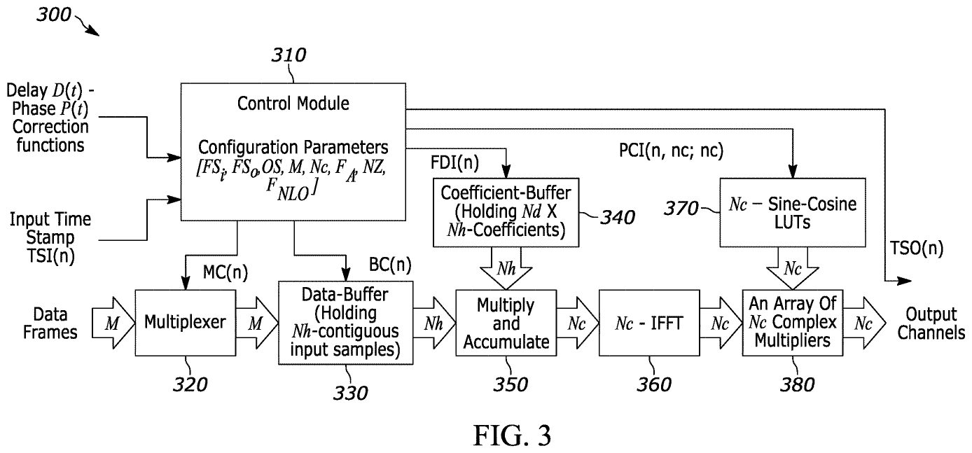

FIG. 3 shows a wideband resampling channelizer 300 that combines channelization and resampling operations, according to an embodiment. A control module 310 controls operation of a plurality of signal processing modules, based on configuration parameters.

The signal processing modules include a multiplexer 320, data buffer 330, coefficient-buffer 340, multiply and accumulate module 350, inverse fast Fourier transform (IFFT) module 360, sine-cosine look up table (LUT) 370 and array of complex multipliers 380.

The configuration parameters for controlling the signal processing modules include: input sampling rate [FSᵢ]), output sampling rate [FSₒ], over-sampling factor [OS], number of de-multiplexed (i.e. parallel) samples per input frame [M], number of output channels [Nc], number of phase steps in the sine-cosine LUTs 370, net frequency shift before digitization [N_{FLO}], additional frequency-shift [F_{A}], Nyquist zone of the initial sampling [NZ], and in particular for radio astronomical applications delay correction [D(t)] and phase correction [P(t)], most commonly in polynomial form and updated as required, and input time-stamp TSI(n) for tagging the samples/frames. The [N_{FLO}], [F_{A}] and [NZ] parameters are used evaluate the additional phase correction factors that are subsequently added to [P(t)].

In addition to the foregoing parameters, coefficients of the number of delay-steps [N_{d}] (i.e. number of the fractional delay filters each of length Nₕ) are stored in the coefficient buffer 340. These fractional delay filters are indexed in the coefficient buffer 340 such that the k^{th} filter can compensate fractional-sample delay of 1/k at the input sample rate. Additionally, an array of sine-cosine values are stored in sine-cosine LUTs 370, containing data and logic to facilitate the equivalent of Nₚ phase steps for the Nc output channels.

The following signal and parameters are output from the control module 310: multiplexer control signal MC(n), to control the input multiplexer 320 to facilitate the ‘contiguous-flow’ of the time de-multiplexed input samples into the data buffer 330 and hold the input sample frames until those are needed; buffer-control signal BC(n), that controls the sample flow in the data buffer 330 to position the Nh required contiguous samples accordingly; fractional delay filter index FDI(n), to select the fractional filter within coefficient buffer 340 for the required delay correction among N_{d} such filters; phase compensation indices PCI(n,nc); ncε(0,1, . . . Nc−1), used to select the corresponding multiplication factors from the sine-cosine LUTs 370 for phase/frequency correction/adjustment for the Nc output channels and output time stamp TSO(n), which tags the output samples/frames with the time code relative to the input samples.

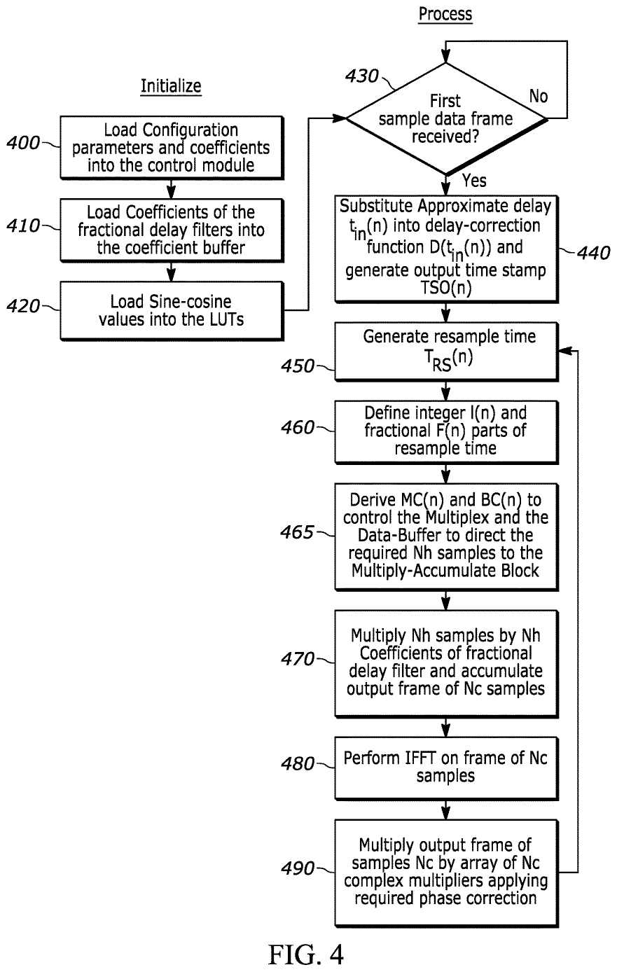

Operation of the wideband resampling channelizer 300 is set forth in the flowchart of FIG. 4. Steps 400-420 are initialization steps whereas the remaining steps set forth operation of the control channelizer 300 on an input sequence of data frames.

At 400, configuration parameters FSᵢ, FSₒ, OS, M, Nc, N_{d}, Nₗ, N_{FLO}, F_{A}, NZ and the coefficients of the polynomials D(t) and P(t) are loaded into registers of the control module 310. At 410, coefficients of the N_{d} fractional delay filters into the coefficient buffer 340. At 420, sine-cosine values are loaded into the sine-cosine LUTs 370.

Upon receipt of the first M-sample data frame at 430, the output time stamp is generated at 440 using TSI(n) and FSᵢ to find the time of the input frame tᵢₙ(n), and evaluating the approximate delay at tᵢₙ(n) by substituting this time to the delay-correction function D(tᵢₙ(n)), such that the output time-stamp is given by TSO(n)=round[(tᵢₙ(n)+D(tᵢₙ(n))·FSₒ].

At 450, the resample time is generated using TSO(n) and FSₒ to find the time of the output sample tₒᵤₜ(n), and evaluating the corresponding resample time such that t_{RS}(n)=tₒᵤₜ(n)−D(tₒᵤₜ(n)).

At 460, the ‘integer’ part of the resample time I(n)=floor[t_{RS}(n). Fᵢ] and the residual ‘fractional’ part of the resample time F(n)=t_{RS}(n)·Fᵢ−I(n) are defined.

At 465, MC(n) and BC(n) are derived to control the multiplexer 320 and the data buffer 330 to direct the required Nh samples to the multiply and accumulate module 350.

At 470, the properly arranged Nh samples in the data buffer 330 are multiplied in multiplier 350 by Nh coefficients of the fractional delay filter FDI(n) selected from coefficient-holding buffer 340, and accumulated into a frame of Nc samples, where the multiplication product corresponds to coefficient-index mod(k, Nc); kε(0,1, . . . , Nh−1).

At 480, the accumulated output frame of sample Nc is subjected to a parallel inverse Fourier transform in Nc-IFFT module 360.

At 490, the output frame from the IFFT module 360 is then multiplied by the array of Nc complex multipliers 380 applying the required phase variations from sine-cosine look up table (LUT) 370 specified by the phase compensation indices PCI(n,nc); ncε(0,1, . . . Nc−1), that are derived in the control module 310 according to the phase-correction function P(t) and the parameters F(n), N_{FLO}, F_{A} and NZ.

Steps 450 to 490 are repeated with the updated tₒᵤₜ such that tₒᵤₜ(n+1)=tₒᵤₜ(n)+1/ FSₒ.

From the foregoing, it will be noted that the method of FIG. 4 by which the control module 310 drives the multiplexer 320 and the data buffer 330 facilitates a contiguous sample flow based on the configuration parameters set forth above. This in turn facilitates sample rate changes and also the integer and fractional-delay corrections and phase-corrections that are specified by the delay correction function D(t) and phase correction function P(t), respectively.

Furthermore, the filters employed in wideband resampling channelizer 300 facilitate both fractional time-delay for resampling and frequency selection for channelization, resulting in reduced cost, power utilization and development/test/verification times due to the use of fewer digital signal processing devices than the prior art system of FIG. 1.

The description of exemplary embodiments of the present disclosure provided below is merely exemplary and is intended for purposes of illustration only; the following description is not intended to limit the scope of the invention disclosed herein. Moreover, recitation of multiple embodiments having stated features is not intended to exclude other embodiments having additional features or other embodiments incorporating different combinations of the stated features.

The present invention has been described above with reference to a number of exemplary embodiments and examples. It should be appreciated that the particular embodiments shown and described herein are illustrative of the invention and its best mode and are not intended to limit in any way the scope of the invention as set forth in the claims. The features of the various embodiments may stand alone or be combined in any combination. Further, unless otherwise noted, various illustrated steps of a method can be performed sequentially or at the same time, and not necessarily be performed in the order illustrated. It will be recognized that changes and modifications may be made to the exemplary embodiments without departing from the scope of the present invention. These and other changes or modifications are intended to be included within the scope of the present invention, as expressed in the following claims.

1. A wideband resampling channelizer, comprising
a control module for receiving delay and phase correction functions and an input time stamp, and in response outputting a plurality of control signals and and output time stamp based on a plurality of configuration parameters;
a multiplexer for receiving input data samples and outputting time de-multiplexed input samples based on a multiplexer control signal output from the control module;
a data buffer for receiving the time de-multiplexed input samples and outputting a contiguous flow of the data samples based on a buffer-control signal output from the control module;
a coefficient-buffer for storing a plurality of fractional filters and outputting selected fractional filters for the contiguous flow of the data samples, based on a fractional delay filter index output from the control module;
a multiply and accumulate module for multiplying the samples output from the data buffer by respective coefficients of the fractional filters output from the coefficient buffer for a required delay correction, and accumulating the multiplication product into a frame of samples;
an inverse fast Fourier transform module for performing an inverse fast Fourier transform on the frame of samples,
sine-cosine look up table for storing a plurality of multiplication factors; and
an array of complex multipliers for multiplying the frame of samples output from inverse fast Fourier transform module by corresponding multiplication factors from the sine-cosine look up table based on phase compensation indices output from the control module and in response outputting a plurality of output channels that are adjusted for phase and frequency and tagged with the output time stamp for relation to the input data samples.

2. A method of operating the wideband resampling channelizer of claim 1, comprising:
a) loading the following configuration parameters into registers of the control module: input sampling rate [FSᵢ], output sampling rate [FSₒ], over-sampling factor [OS], number of de-multiplexed (i.e. parallel) samples per input frame [M], number of output channels [Nc], number of phase steps in the sine-cosine LUTs 370, net frequency shift before digitization [N_{FLO}], additional frequency-shift [F_{A}], Nyquist zone of the initial sampling [NZ], delay correction [D(t)] phase correction [P(t)] and input time-stamp TSI(n);
b) loading coefficients of N_{d} fractional delay filters into the coefficient buffer;
c) loading sine-cosine values into the sine-cosine look up table;
d) upon receipt of an M-sample frame, generating the output time stamp by evaluating an approximate delay at a time of an input data sample tᵢₙ(n), using the input time-stamp TSI(n) and input sampling rate FSᵢ and substituting the approximate delay to a delay-correction function D(tᵢₙ(n)), such that the output time-stamp is given by TSO(n)=round[(tᵢₙ(n)+D(tᵢₙ(n)·FSₒ];
e) generating a resample time using the output time stamp TSO(n) and output sampling rate FSₒ to find the time of the output sample tₒᵤₜ(n), and evaluating the corresponding resample time such that t_{RS}(n)=tₒᵤₜ(n)−D(tₒᵤₜ(n));
f) define an integer part of the resample time I(n)=floor[t_{RS}(n)·Fᵢ] and a residual fractional part of the resample time F(n)=t_{RS}(n)·Fᵢ−I(n);
g) derive MC(n) and BC(n) to control the multiplexer and the data buffer to direct Nh samples to the multiply and accumulate module;
h) in the multiplier, multiply Nh arranged samples from the data buffer by Nh coefficients of the fractional delay filter FDI(n) selected from the coefficient-holding buffer, and accumulating into a frame of Nc samples, where the multiplication product corresponds to coefficient-index mod(k,Nc); kε(0,1, . . . , Nh−1);
i) in the inverse Fourier Transform module performing a parallel inverse Fourier Transform on the frame of sample Nc;
j) in the array of complex multipliers multiplying the output frame from the inverse Fourier Transform module by the corresponding multiplication factors from the sine-cosine look up table specified by the phase compensation indices PCI(n,nc); ncε(0,1, . . . Nc−1), derived in the control module according to the phase-correction function P(t) and the parameters F(n), N_{FLO}, F_{A} and NZ; and
repeating e) to j) with an updated tout such that tₒᵤₜ(n+1)=tₒᵤₜ(n)+1/FSₒ.

3. The method of claim 2, wherein the fractional delay filters are indexed in the coefficient buffer such that the k^{th} filter can compensate fractional-sample delay of 1/k at the input sampling rate [FSᵢ].

4. The method of claim 2, wherein the plurality of multiplication factors stored in the sine-cosine look up table facilitates Nₚ phase steps for the Nc output channels.

5. A wideband resampling channelizer, comprising
a plurality of signal processing modules for generating a plurality of output channels that are adjusted for phase and frequency and tagged with an output time stamp in relation to the input data samples; and
a control module for controlling the plurality of signal processing modules based on a plurality of configuration parameters such that channelization and resampling operations are combined.

6. The wideband resampling channelizer of claim 5, wherein the plurality of signal processing modules includes a multiplexer for receiving input data samples and outputting time de-multiplexed input samples based on a multiplexer control signal output from the control module.

7. The wideband resampling channelizer of claim 6, wherein the plurality of signal processing modules includes a data buffer for receiving the time de-multiplexed input samples and outputting a contiguous flow of the data samples based on a buffer-control signal output from the control module.

8. The wideband resampling channelizer of claim 7, wherein the plurality of signal processing modules includes a coefficient-buffer for storing a plurality of fractional filters and outputting selected fractional filters for the contiguous flow of the data samples, based on a fractional delay filter index output from the control module.

9. The wideband resampling channelizer of claim 8, wherein the plurality of signal processing modules includes a multiply and accumulate module for multiplying the samples output from the data buffer by respective coefficients of the fractional filters output from a coefficient buffer for a required delay correction, and accumulating the multiplication product into a frame of samples.

10. The wideband resampling channelizer of claim 9, wherein the plurality of signal processing modules includes an inverse fast Fourier transform module for performing an inverse fast Fourier transform on the frame of samples.

11. The wideband resampling channelizer of claim 10, wherein the plurality of signal processing modules includes a sine-cosine look up table for storing a plurality of multiplication factors.

12. The wideband resampling channelizer of claim 11, wherein the plurality of signal processing modules includes an array of complex multipliers for multiplying the frame of samples output from inverse fast Fourier transform module by corresponding multiplication factors from the sine-cosine look up table based on phase compensation indices output from the control module and in response outputting a plurality of output channels that are adjusted for phase and frequency and tagged with the output time stamp for relation to the input data samples.

13. The wideband resampling channelizer of claim 11, wherein the configuration parameters include: input sampling rate [FSᵢ], output sampling rate [FSₒ], over-sampling factor [OS], number of de-multiplexed (i.e. parallel) samples per input frame [M], number of output channels [Nc], number of phase steps in the sine-cosine LUTs 370, net frequency shift before digitization [N_{FLO}], additional frequency-shift [F_{A}], Nyquist zone of the initial sampling [NZ], delay correction [D(t)] phase correction [P(t)] and input time-stamp TSI(n).

14. The wideband resampling channelizer of claim 13, wherein the coefficient buffer stores coefficients of N_{d} fractional delay filters.

15. The wideband resampling channelizer of claim 14, wherein the sine-cosine look up table stores sine-cosine values.

16. The wideband resampling channelizer of claim 15, wherein upon receipt of an M—sample frame, the control module i) generates the output time stamp by evaluating an approximate delay at a time of an input data sample tᵢₙ(n), using the input time-stamp TSI(n) and input sampling rate FS_{i;} and substituting the approximate delay to a delay-correction function D(tᵢₙ(n)), such that the output time-stamp is given by TSO(n)=round[(tᵢₙ(n)+D(tᵢₙ(n)·FSₒ], ii) generates a resample time using the output time stamp TSO(n) and output sampling rate FSₒ to find the time of the output sample tₒᵤₜ(n), and evaluating the corresponding resample time such that t_{RS}(n)=tₒᵤₜ (n)−D(tₒᵤₜ(n), and iii) defines an integer part of the resample time I(n)=floor [t_{RS}(n)·Fᵢ] and a residual fractional part of the resample time F(n)=t_{RS}(n)·Fᵢ−I(n).

17. The wideband resampling channelizer of claim 16, wherein the multiplier is operable to multiply Nh arranged samples from the data buffer by Nh coefficients of the fractional delay filter FDI(n) selected from the coefficient-holding buffer, and accumulate the multiplication product into a frame of Nc samples, where the multiplication product corresponds to coefficient-index mod(k, Nc); kε(0,1, . . . , Nh−1).

18. The wideband resampling channelizer of claim 17, wherein the inverse Fourier Transform module is operable to perform a parallel inverse Fourier Transform on the frame of sample Nc.

19. The wideband resampling channelizer of claim 18, wherein the array of complex multipliers is operable to multiply the output frame from the inverse Fourier Transform module by the corresponding multiplication factors from the sine-cosine look up table specified by the phase compensation indices PCI(n, nc); ncε(0,1, . . . Nc−1), derived in the control module according to the phase-correction function P(t) and the parameters F(n), N_{FLO}, F_{A} and NZ.

20. The wideband resampling channelizer of claim 19, wherein the fractional delay filters are indexed in the coefficient buffer such that the k^{th} filter can compensate fractional-sample delay of 1/k at the input sampling rate [FSᵢ], and wherein the plurality of multiplication factors stored in the sine-cosine look up table facilitates Nₚ phase steps for the Nc output channels.
